(19) United States
(12) Patent Application Publication
(10) Pub. No.: US 2020/0131647 A1
(43) Pub. Date: Apr. 30, 2020

(54) METHOD AND SYSTEM FOR PRODUCING A GAS PRODUCT CONTAINING CARBON MONOXIDE

(71) Applicant: Linde Aktiengesellschaft, München (DE)

(72) Inventors: Werner LEITMAYR, Neuburg/Donau (DE); Clara DELHOMME-NEUDECKER, München (DE); Andreas PESCHEL, Wolfratshausen (DE); Benjamin HENTSCHEL, München (DE); Anette FRANZ, München (DE)

(21) Appl. No.: 16/621,139

(22) PCT Filed: May 30, 2018
(86) PCT No.: PCT/EP2018/000278

§ 371 Date: Dec. 10, 2019

(30) Foreign Application Priority Data
Jun. 14, 2017 (DE) 102017005680.3

(51) Int. Cl. C25B 1/00; B01D 53/047; B01D 53/22; C01B 32/40

(52) U.S. Cl. CPC C25B 1/00; B01D 53/047; B01D 53/229; B01D 2256/20; B01D 2257/504; B01D 2259/40007; C01B 32/40

(57) ABSTRACT

The invention relates to a method (100-500) for producing a gas product containing at least carbon monoxide, in which method at least carbon dioxide is subjected to an electrolysis process (10) in order to obtain a raw gas (A) containing at least carbon monoxide and carbon dioxide and the carbon dioxide contained in the raw gas (A) is partially or completely fed back to the electrolysis process (10). According to the invention, the raw gas (A) is partially or completely subjected to a membrane separation process (20) in order to obtain a retentate mixture (B) and a permeate mixture (C), which is enriched in carbon dioxide in comparison with the raw gas (A), and that the retentate mixture (B) is partially or completely subjected to a pressure swing adsorption process (40) in order to obtain the gas product (D), which is enriched in carbon monoxide and depleted of carbon dioxide in comparison with the retentate mixture (B), and a residual mixture (E), which is depleted of carbon monoxide and enriched in carbon dioxide in comparison with the retentate mixture (B). The invention further relates to a corresponding system.

The present invention relates to a method and to a system for producing a gas product containing at least carbon monoxide according to the respective preambles of the independent claims.

### PRIOR ART

Carbon monoxide can be produced by means of a number of different processes, e.g., together with hydrogen by steam reforming of natural gas and subsequent purification from the formed synthesis gas, or by the gasification of raw materials such as coal, petroleum, natural gas, or biomass and subsequent purification from the formed synthesis gas. In addition to the production of carbon monoxide or carbon monoxide-rich gas mixtures, the present invention also relates to the production of synthesis gas, i.e., in general, the production of gas products that can contain at least carbon monoxide, but also further components typically present in synthesis gas—in particular, hydrogen.

The electrochemical production of carbon monoxide from carbon dioxide is likewise known and appears to be attractive, in particular, for applications in which the traditional production by steam reforming is overdimensioned and thus uneconomical. In particular, high-temperature (HT) electrolysis, which is carried out using one or more solid oxide electrolysis cells (SOEC), can be used for this purpose. Oxygen forms thereby on the anode side, and carbon monoxide forms on the cathode side, according to the following chemical equation:

CO₂→CO+½O₂ (1)

As a rule, carbon dioxide is not completely converted into carbon monoxide during the electrochemical production of carbon monoxide from carbon dioxide during a single pass through the electrolysis cell(s), so that carbon dioxide is typically at least partially separated from a gas mixture formed during electrolysis and fed back to the electrolysis.

The explained electrochemical production of carbon monoxide from carbon dioxide is described, for example, in WO 2014/154253 A1, WO 2013/131778 A2, WO 2015/014527 A1, and EP 2 940 773 A1. A separation of a gas mixture formed during electrolysis, using absorption, adsorption, membrane, and cryogenic separation processes, is likewise disclosed in the cited publications, but no details are provided as to the specific design and, in particular, as to a combination of the methods.

In solid oxide electrolysis cells, water can also be subjected to electrolysis, in addition to carbon dioxide, so that a synthesis gas containing hydrogen and carbon monoxide can be formed. Details in this regard are indicated, for example, in an article from Foit et al. (2016), Angew. Chem., DOI: 10.1002/ange.201607552, which was published online before going to press. Such methods can also be used within the scope of the present invention and are referred to hereafter as HT co-electrolysis.

The electrochemical production of carbon monoxide from carbon dioxide is also possible by means of low-temperature (LT) electrolysis on aqueous electrolytes (also referred to herein as LT co-electrolysis). The following reactions take place:

CO₂+2e⁻+2M⁺+H₂O→CO+2MOH (2)

2MOH→½O₂+2M⁺+2e⁻+H₂O (3)

For a corresponding LT co-electrolysis, a membrane is used, through which the positive charge carriers (M⁺) required according to reaction equation 2, or formed according to reaction equation 3, migrate from the anode side to the cathode side. In contrast to HT electrolysis using solid oxide electrolysis cells, the positive charge carriers here are not transported in the form of oxygen ions, but, for example, in the form of positive ions of the electrolyte salt used (a metal hydroxide, MOH). An example of a corresponding electrolyte salt might be potassium hydroxide. In this case, the positive charge carriers are potassium ions. Further embodiments of LT electrolysis include, for example, the use of proton exchange membranes (PEM) through which protons migrate, or of what are known as anion exchange membranes (AEM). Different variants of corresponding methods are described, for example, in Delacourt et al. (2008), J. Electrochem. Soc. 155(1), B42-B49, DOI: 10.1149/1.2801871.

The presence of water in the electrolyte solution also partially results in the formation of hydrogen at the cathode:

2H₂O+2M⁺+2e⁻→H₂+2MOH (4)

Depending on the catalyst used, additional useful products can also be formed during the LT co-electrolysis. In particular, HT co-electrolysis can be carried out to form varying amounts of hydrogen. Corresponding methods and devices are described, for example, in WO 2016/124300 A1 and WO 2016/128323 A1. However, suitable separation concepts for the gas mixtures formed during a corresponding electrolysis, and process concepts in connection with electrolysis, have not yet been described in the literature.

The aim of the present invention is therefore to show concepts for separating corresponding gas mixtures, which, in addition to carbon monoxide and carbon dioxide, can also contain hydrogen.

### DISCLOSURE OF THE INVENTION

Against this background, the present invention proposes a method for producing a gas product containing at least carbon monoxide and a corresponding system having the features of the respective independent patent claims. Preferred embodiments are the subject matter of the dependent claims and the following description.

As already mentioned, a “gas product containing at least carbon monoxide” here is understood to mean, in particular, carbon monoxide of different purities or else synthesis gas or a comparable gas mixture, i.e., a gas mixture that also contains at least appreciable amounts of hydrogen, in addition to carbon monoxide. Further details are explained below.

One essential aspect of the present invention is the use of a membrane method or a membrane separation process upstream of the formation of the aforementioned gas product from the raw gas of carbon dioxide electrolysis or co-electrolysis by means of adsorption, e.g., pressure swing adsorption (PSA) or temperature swing adsorption (TSA), i.e., the use of pre-separation by way of a membrane process upstream of the adsorption process.

Within the scope of the present invention, the carbon dioxide electrolysis or co-electrolysis can take place in the form of an HT electrolysis process, using one or more solid oxide electrolysis cells, or as an LT co-electrolysis process, e.g., using a proton exchange membrane and an electrolyte salt in aqueous solution—in particular, a metal hydroxide. In principle, the LT co-electrolysis can be carried out using different liquid electrolytes, e.g., on an aqueous basis—in particular, with electrolyte salts—on a polymer basis or in other embodiments. If HT electrolysis is used, water can additionally be supplied to the solid oxide electrolysis cell, or the solid oxide electrolysis cells, so that co-electrolysis takes place and hydrogen is formed. During HT co-electrolysis, the presence of water typically causes a certain, but variable degree of hydrogen formation, as a function of the particular specific design of the process.

By selecting a suitable membrane in the membrane separation and by suitably dimensioning a corresponding membrane, it can be ensured that an undesirable accumulation of hydrogen in the gas product, i.e., for example, in particular, if the gas product to be formed is carbon monoxide, does not result in undesirable contamination of the carbon monoxide, and at the same time does not result in an accumulation of hydrogen in a cycle formed by the recirculation of carbon dioxide.

In addition, a portion of the carbon dioxide in the raw gas is already separated upstream of the adsorption process, so that this can be on a considerably smaller scale. The advantages achievable within the scope of the present invention are manifested in all electrolysis and product variants explained above (HT electrolysis, HT co-electrolysis, LT co-electrolysis, production of carbon monoxide or synthesis gas).

In the case of LT co-electrolysis and the production of carbon monoxide, comparatively small amounts of hydrogen are formed during the electrolysis process. The advantages of using the membrane method here are that this hydrogen can be at least partially separated and does not find its way at all, or does so in smaller portions, into the carbon monoxide being provided as the gas product. Even if the raw gas here contains no or almost no hydrogen, a portion of the carbon dioxide can be separated by means of the membrane, and thus the adsorption process can be on a smaller scale and thus be implemented more cost-effectively.

In the case of LT co-electrolysis and the production of synthesis gas, in which comparatively large amounts of hydrogen are formed in contrast to the production of carbon monoxide, the use of a hydrogen-separating membrane or a corresponding hydrogen separation process does not offer any direct advantages. However, by using a carbon dioxide-separating membrane, the subsequent adsorption process can also be on a smaller scale here.

In the case of HT co-electrolysis and the production of synthesis gas, the advantages of using a membrane method are, in particular, that hydrogen is partially separated from the raw gas, together with a portion of the carbon dioxide, and can be recycled together with the carbon dioxide. The adsorption process can be on a smaller scale. The recirculating of hydrogen is, due to its reducing properties, particularly advantageous for the raw materials used in the heat exchangers and the electrolysis unit in the case of HT co-electrolysis. Through the selection of the dimensioning of the membrane, it is possible to achieve that, nonetheless, most of the generated hydrogen finds its way into the adsorption process and then into the gas product.

With HT electrolysis for the production of carbon monoxide, in which no hydrogen is formed, the advantage of using a membrane method is also the possibility of reducing the scale of the adsorption process, as mentioned on several occasions. A portion of the carbon monoxide in the raw gas is recycled to the solid oxide electrolysis cell and has a positive effect on the redox potential.

Within the scope of the present invention, a simple, cost-effective, and technically uncomplicated, on-site production of carbon monoxide or synthesis gas by carbon dioxide electrolysis according to one of the explained techniques is possible. In this way, carbon monoxide or synthesis gas can be provided to a consumer, without having to resort to the known methods, such as the potentially overdimensioned steam reforming. The production on site makes it possible to dispense with a cost-intensive and potentially unsafe transport of carbon monoxide or synthesis gas. Within the scope of the present invention, there is the possibility of flexible purification of an electrolysis raw product or of a raw gas provided by means of electrolysis—which gas is predominantly composed of carbon monoxide and carbon dioxide and, optionally, hydrogen and water—to yield carbon monoxide products of varying purity levels or to yield synthesis gas while recirculating carbon dioxide to the electrolysis process.

Overall, the present invention proposes a method for producing a gas product containing at least carbon monoxide, in which at least carbon dioxide is subjected to an electrolysis process to obtain a raw gas containing at least carbon monoxide and carbon dioxide. With regard to the electrolysis processes that can be used within the scope of the present invention, reference is made to the above explanations. The present invention is described hereafter with, in particular, reference to the LT co-electrolysis of carbon dioxide and water; however, an HT electrolysis process can also readily be used, in which hydrogen can likewise be present in the raw gas—in particular if water is additionally subjected to electrolysis in the process, or if hydrogen is mixed into the electrolysis raw product for corrosion protection.

As a result, when it is mentioned here that “at least carbon dioxide” is subjected to the electrolysis process, this does not preclude further components of a feed mixture, which can be used within the scope of the present invention and supplied to the electrolysis process, from also being subjected to the electrolysis process. As explained at the outset, this can, in particular, be water, which can be converted into hydrogen and oxygen. In this way, a gas mixture comprising the typical components of synthesis gas can be obtained, as also explained above.

Any gas mixture that is provided, using an electrolysis process, to which carbon dioxide is (also, but not exclusively) subjected, is referred to as a “raw gas” in the language used herein. In addition to the aforementioned components, the raw gas may also contain, for example, oxygen or non-converted inert components, wherein, here and hereafter, “inert” components shall be understood to mean not only the traditional inert gases, but all the compounds not converted in a corresponding electrolysis process. The electrolysis process carried out within the scope of the present invention can be carried out using one or more electrolysis cells, one or more electrolyzers, each having one or more electrolysis cells, or one or more other structural units used for the electrolysis process.

As is generally known, but only described in general form in the prior art, carbon dioxide contained in the raw gas can be partially or completely fed back to the electrolysis process so as to improve the yield of a corresponding method. In this context, it is also true that, when it is mentioned here that “carbon dioxide” is fed back to the electrolysis process, this does not preclude further components from also being fed back, deliberately or unintentionally, to the electrolysis process—for example, as will also be explained below, by partially directly recirculating raw gas without separating certain components. A corresponding recirculation can, optionally, take place in the method according to the invention, but is not a prerequisite for achieving the advantages according to the invention.

Within the scope of the present invention, it is provided that the raw gas be partially or completely subjected to a membrane separation process to obtain a retentate mixture and a permeate mixture, which is enriched in carbon dioxide in comparison with the raw gas. The retentate mixture can, in particular, be enriched in carbon monoxide and depleted of carbon dioxide in comparison with the raw gas. The retentate mixture is, furthermore, depleted of carbon dioxide—in particular, in comparison with the raw gas. In particular, the retentate mixture can also be depleted of hydrogen in the membrane separation process in comparison with the raw gas, or the permeate mixture can also be enriched in hydrogen in comparison with the raw gas if hydrogen is present in the raw gas in a higher content than is desired in the gas product—for example, if the gas product to be formed is carbon monoxide.

In addition, material flows, gas mixtures, and the like may, in the language used herein, be rich in or poor in one or more components, wherein the term, “rich,” may represent a content of at least 50%, 60%, 75%, 80%, 90%, 95%, 98%, 99%, 99.5%, 99.9%, or 99.99%, and the term, “poor,” may represent a content of no more than 50%, 40%, 25%, 20%, 10%, 5%, 2%, 1%, 0.5%, 0.1%, or 0.01% on a molar, weight, or volume basis. When multiple components are specified, the term, “rich” or “poor,” refers to the sum of all components. For example, if “carbon monoxide” is mentioned here, this may refer to a pure gas, but also a mixture rich in carbon monoxide. A gas mixture “predominantly” containing one or more components is, in particular, rich in this component or in these components in the sense described.

Material flows, gas mixtures, and the like may furthermore be “enriched” in or “depleted” of one or more components in the language used herein, wherein these terms refer to a content in a starting mixture. They are “enriched” if they have a content of at least 1.1 times, 1.5 times, 2 times, 5 times, 10 times, 100 times, or 1,000 times, and “depleted” if they have a content of no more than 0.9 times, 0.75 times, 0.5 times, 0.1 times, 0.01 times, or 0.001 times, of one or more components, with respect to the starting mixture.

As already mentioned, the use of a membrane separation process upstream and in addition to a separation process by adsorption within the scope of the present invention makes it possible to prevent hydrogen from passing into a carbon monoxide-rich gas product of the method. If hydrogen is present when adsorption is used, it typically passes into the gas product together with carbon monoxide and is more difficult to separate from carbon monoxide afterwards.

Within the scope of the present application, a “permeate mixture” is understood to mean a mixture predominantly or exclusively comprising components that are not, or predominantly not, retained by a membrane used in a membrane separation process, i.e., which pass through the membrane (substantially, or at least preferably) unimpeded. Within the scope of the invention, a membrane is used which preferably allows hydrogen (if present) and carbon dioxide to pass, but preferably retains carbon monoxide. In this way, the permeate mixture is enriched at least in carbon dioxide. Such a membrane is, for example, a commercial polymer membrane, which are used on a large scale for separating carbon dioxide and/or hydrogen. Accordingly, a “retentate mixture” is a mixture predominantly comprising components that are completely or at least predominantly retained by the membrane used in the membrane separation process. However, as will be explained below, it is also possible to use carbon dioxide-selective membranes, which specifically allow carbon dioxide to pass.

Within the scope of the present invention, the retentate mixture is partially or completely subjected to an adsorption process to obtain the gas product that is enriched in carbon monoxide and depleted of carbon dioxide in comparison with the retentate mixture—in particular, a gas product or synthesis gas that is rich in carbon dioxide in the above sense and, at most, still contains small proportions of secondary components—and a residual mixture that is depleted of carbon monoxide and enriched in carbon dioxide in comparison with the retentate mixture. Within the scope of a preferred embodiment of the present invention, the permeate mixture and/or the residual mixture are, furthermore, partially or completely fed back to the electrolysis process. One or more accordingly recirculated material flows are also referred to as “recirculation flows” within the scope of this application. A recirculation flow may, for example, be a collection flow formed of the permeate mixture and the residual mixture or portions thereof. With respect to the particular advantages of such a procedure, reference is made to the above explanations.

Within the scope of the present invention, the electrolysis can be carried out at a pressure level corresponding to a pressure level at which the raw gas is supplied to the membrane separation process (i.e., deviates by no more than 1 bar, for example), wherein the recirculation flow or flows is compressed to the pressure level of the electrolysis using one or more compressors—so-called recycle compressors. In such a case, the raw gas does not have to be compressed.

Alternatively, however, the electrolysis can also be carried out at a pressure level that is lower (for example, at least 1, 2, 3, 4, 5, 10, 20, 40, or 80 bar lower) than a pressure level at which the raw gas is supplied to the membrane separation process. In this case, the raw gas is compressed to the pressure level of the membrane separation process, using one or more compressors—so-called raw gas compressors. In this case, a recycle compressor may, optionally, be dispensed with. In general, larger amounts of gas have to be compressed in this alternative, but the electrolysis can be carried out at a lower pressure, and thus possibly more easily.

As mentioned, it can be provided within the scope of the present invention that water be converted during the electrolysis process, or a hydrogen-containing flow be added downstream of the electrolysis process, so that the raw gas contains hydrogen. In this case, the membrane separation can, advantageously, be carried out in such a way that the retentate mixture is depleted of hydrogen in comparison with the raw gas, and the permeate mixture is enriched in hydrogen in comparison with the raw gas. This applies, in particular, to the case in which carbon monoxide or a carbon monoxide-rich gas mixture is to be formed as the product, but not, or to a lesser degree, to the case in which synthesis gas is to be formed as the product. In particular, when a carbon dioxide-selective membrane is used, as can likewise be used within the scope of an embodiment of the invention, a corresponding depletion or accumulation of hydrogen does not have to take place. A carbon dioxide selective membrane is, in particular, described in Lin, H. et al. (2014), J. Membr. Sci. 457(1), 149-161, DOI: 10.1016/j.memsci.2014.01.020.

To produce a synthesis gas product, a separation of the hydrogen is advantageous—at any event, in the case of HT electrolysis—for obtaining a hydrogen-containing input flow for the electrolysis process, but in general this is not advantageous. In this connection in particular, it is, advantageously, possible to resort to a carbon dioxide-selective membrane so as to obtain the carbon monoxide formed in the electrolysis process and the hydrogen as a retentate mixture. In order to simultaneously recirculate a certain portion of hydrogen, together with carbon dioxide, to the electrolysis process, a combination of a hydrogen-permeable and carbon dioxide-permeable membrane may be employed to obtain a hydrogen-containing recycle flow, and a carbon dioxide-permeable membrane may be employed to obtain a carbon dioxide recycle flow employed.

Within the scope of the embodiment of the present invention just described, it is particularly advantageous that at least a portion of the hydrogen contained in the permeate mixture be discharged from the process if carbon monoxide or a carbon monoxide-rich gas mixture is to be formed as the product. In the production of synthesis gas, a corresponding discharge is generally not necessary. Again, it shall be understood that the statement that “a portion of the hydrogen” is discharged from the process also includes that, in addition to the hydrogen, further components are being discharged. For example, within the scope of the present invention, as will be explained below, it can be provided that a partial flow, in the form of what is known as a purge, be merely branched off from a flow that is recirculated to the electrolysis process, but that hydrogen not be selectively separated or removed. The hydrogen present in a corresponding purge is discharged from the process, but at the same time other present components are also withdrawn from the process. By discharging hydrogen, either alone or together with other components, it is possible to prevent hydrogen from becoming enriched in a cycle formed by the recirculation. However, as will also be explained below, in addition to or as an alternative to such a purge, an—in particular, targeted, i.e., selective—removal of hydrogen is also possible. However, even with such a removal, a portion of the hydrogen present in the permeate mixture is discharged from the process.

Within the scope of the present invention, the permeate mixture and the residual mixture, or portions of these mixtures, are, advantageously, combined to form the recycle flow or flows, thus forming a collection mixture. This collection mixture is partially or completely fed back to the electrolysis process. As mentioned, the need for compression depends on the pressure at which the electrolysis is carried out. The combining and subsequent recirculation to the electrolysis process is possible with the formation of a collection mixture—in particular, by means of only a single compressor, if such compression is required. As an alternative to the formation of a corresponding collection mixture, however, separate pressurization and recirculation is also possible in such a case—in particular, if different pressure differences have to be overcome for the permeate mixture and the residual mixture—for example, because these are formed at different pressure levels.

In this context, in particular, the aforementioned hydrogen removal is possible, to which at least a portion of the recirculation flow or flows, and thus the residual mixture or the permeate mixture—in particular, also in the form of the collection mixture, or a portion thereof—can be subjected. According to this embodiment of the present invention, only what remains after the removal of hydrogen is partially or completely fed back to the electrolysis process. In this way, the hydrogen still present in the permeate mixture, but also the hydrogen present in the residual mixture, can be removed, so that low hydrogen contents can be achieved, and thus particularly clean gas products can be obtained, if this is desired. It goes without saying that this also applies, in particular, when carbon monoxide or a carbon monoxide-rich gas mixture is to be formed as the product.

The removal of hydrogen can, in particular, be carried out in the form of a catalytic and/or a non-catalytic oxidation. In the case of catalytic oxidation, this may, in particular, be selective. As will also be explained in more detail with reference to the accompanying drawings, the catalytic oxidation can be carried out using oxygen, which is likewise formed during the electrolysis. Non-catalytic oxidation can, in particular, comprise a thermal oxidation (combustion) step, which can, in particular, also be carried out using an internal combustion engine—in particular, a gas turbine. This too can, advantageously, be carried out using oxygen, which is formed during the electrolysis. In this way, the overall energy efficiency of the method proposed according to the invention can be further improved.

According to a preferred embodiment of the present invention, a first fraction of the permeate mixture and/or of the residual mixture in the form of the recirculation flow or flows is combined with the raw gas and subjected to the membrane separation process, whereas a second fraction of the permeate mixture and/or of the residual mixture is combined with a fresh supply and fed back to the electrolysis process. Within the scope of this embodiment of the present invention, which is also explained, in particular, in more detail with reference to the accompanying FIG. 2, the carbon monoxide content in the input flow of the electrolysis process can be reduced. As is also mentioned there, depending on the specific design of the electrolysis process, this can be advantageous for the performance and/or service life of the technical equipment used in the electrolysis. Since, in the membrane method used, the membrane selectively separates hydrogen and carbon dioxide from carbon monoxide, the partial recirculation has no influence on the subsequent adsorption, provided that the membrane surface is adapted in a suitable manner.

However, according to an alternative embodiment of the present invention, which will also be explained in more detail—in particular, with reference to the accompanying FIG. 3—it is provided that a first fraction of the raw gas be combined with the recirculation flow or flows and fed back to the electrolysis process, and that a second fraction of the raw gas be subjected to the membrane separation process to obtain the retentate mixture and the permeate mixture. In other words, according to this alternative embodiment, a portion of the raw gas is recirculated directly. In this way, the carbon monoxide content in the electrolysis raw product can be increased. This has a positive effect on the entire separation sequence. Since only the pressure losses of the electrolysis unit have to be overcome in the case of such a recirculation, a cost-effective fan can be used for recirculating the raw gas fraction.

In one embodiment of the method according to the invention, the membrane separation process comprises at least two membrane separation steps, wherein the permeate mixture comprises permeate fractions each formed in the at least two membrane separation steps. According to one embodiment of the present invention, it can also be provided that the membrane separation process comprise at least two membrane separation steps, and that the permeate mixture of a downstream membrane separation step be recirculated to an upstream membrane separation step so as to increase the carbon monoxide yield, while increasing the pressure by means of a compressor. According to a further embodiment of the present invention, it can also be provided that the membrane separation process comprise at least two membrane separation steps, and that the permeate mixture of an upstream membrane separation step be supplied to a downstream membrane separation step, while increasing the pressure by means of a compressor. In the downstream membrane separation step, a retentate mixture is obtained, which is subjected to an upstream membrane separation step so as to increase the carbon monoxide yield.

Within the scope of the present invention, the permeate mixture and the residual mixture are each preferably formed at a pressure level of 1 to 10 bar or 1 to 5 bar—in particular. at a pressure level of 1 to 2 bar, e.g., a pressure level of 1 to 1.5 bar, or at a pressure level of approximately 1.2 bar.

The contents of hydrogen, carbon monoxide, and carbon dioxide depend on the electrolysis method that is carried out (HT electrolysis, HT co-electrolysis, LT co-electrolysis) and the desired gas product (carbon monoxide or synthesis gas).

According to a first embodiment of the present invention, it is provided that the gas product to be formed be a carbon monoxide-rich gas mixture, wherein the gas product contains 90 to 100%—in particular, 95 to 100%, e.g., 98 to 100%—carbon monoxide. This is then a carbon monoxide product. The raw gas may contain 10 to 95%—in particular, 20 to 90%, and, advantageously, 30 to 70%—carbon monoxide, 0 to 20%—in particular, 1 to 15%, and, advantageously, 1 to 10%—hydrogen, and 5 to 90%—in particular, 20 to 80%, and, advantageously, 30 to 70%—carbon dioxide.

In this first embodiment, the retentate mixture (RM) and the permeate mixture (PM) may, in particular, have the contents of carbon monoxide (CO), hydrogen (H₂), and carbon dioxide (CO₂) indicated in the table below.

| | RM | PM |
|---|---|---|
| CO | 80% | 15% |
| H₂ | 0.5% | 5% |
| CO₂ | 19.5% | 80% |

According to a second, alternative embodiment of the present invention, it is provided that a gas mixture containing carbon monoxide and hydrogen, i.e., a synthesis gas product, be produced, having a ratio of hydrogen to carbon monoxide of approximately 1 to 4, or having a stoichiometric number of 0.8 to 2.1, wherein the gas product contains in total 90 to 100%—in particular, 95 to 100%, and, advantageously, 99 to 100%—carbon monoxide and hydrogen. The stoichiometric number SN is calculated from the molar fractions x of hydrogen, carbon dioxide, and carbon monoxide as SN=(x H₂−−x CO₂)/(x CO+x CO₂). Typical fields of use for synthesis gases can vary, as is known to the person skilled in the art, as a function of the ratio of hydrogen to carbon monoxide.

In this alternative second embodiment, the retentate mixture (RM) and the permeate mixture (PM) for the respectively indicated ratios of hydrogen to carbon monoxide (H₂/CO) may, in particular, have the contents of carbon monoxide (CO) hydrogen (H₂), and carbon dioxide (CO₂) indicated in the table below.

| | RM | PM |
|---|---|---|
| H₂/CO = 1 | | |
| CO | 54% | 16% |
| H₂ | 38% | 11% |
| CO₂ | 8% | 73% |
| H₂/CO = 2 | | |
| CO | 40% | 13% |
| H₂ | 53% | 17% |
| CO₂ | 7% | 70% |

Examples of contents of the above-mentioned mixtures of hydrogen, carbon monoxide, and carbon dioxide are also provided, in particular, with reference to the accompanying drawings. The percentages denote a molar-based content.

The present invention also covers a system for producing a gas product containing carbon monoxide, according to the corresponding independent claim.

Regarding features and advantages of the system proposed according to the invention, reference is expressly made to the above explanations regarding the method according to the invention and the embodiments thereof. This also applies to a system according to a particularly preferred embodiment of the present invention, which is designed to carry out a method as described above in the embodiments thereof.

The invention will be described in more detail hereafter with reference to the accompanying drawings, which illustrate preferred embodiments of the present invention.

### BRIEF DESCRIPTION OF THE DRAWINGS

FIG. 1 illustrates a method according to an embodiment of the invention.

FIG. 2 illustrates a method according to an embodiment of the invention.

FIG. 3 illustrates a method according to an embodiment of the invention.

FIG. 4 illustrates a method according to an embodiment of the invention.

FIG. 5 illustrates a method according to an embodiment of the invention.

### DETAILED DESCRIPTION OF THE DRAWINGS

In the figures, method steps, technical units, apparatuses, and the like, which correspond to one another in terms of function and/or design or structure, are denoted by identical reference symbols and are not explained repeatedly, for the sake of clarity. Even though methods according to embodiments of the invention are illustrated in the drawings and will be explained in more detail below, the corresponding explanations apply similarly to systems configured according to the embodiments of the invention. As a result, where method steps are explained hereafter, these explanations apply similarly to system parts.

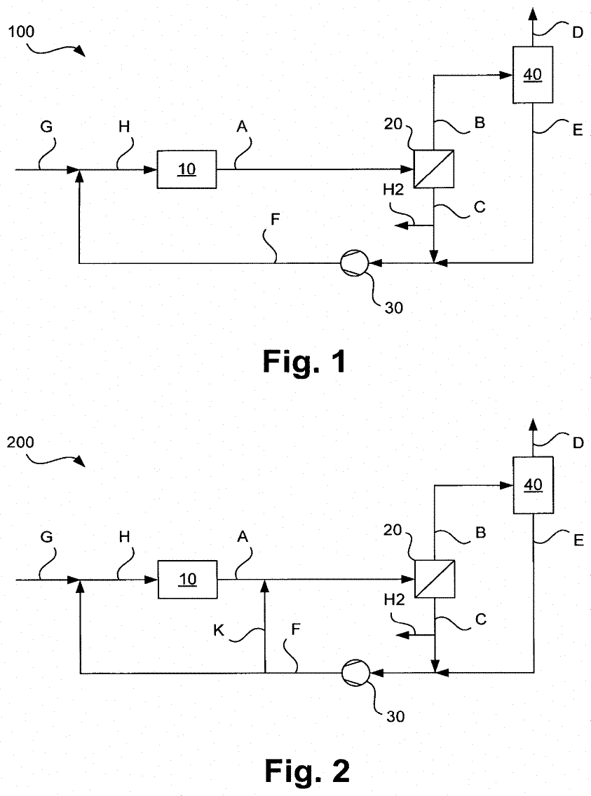

FIG. 1 schematically illustrates a method according to an embodiment of the invention and is denoted overall by 100.

An electrolysis process 10 is provided as an essential method step of the method 100, which can be carried out, in particular, in the form of a high-temperature electrolysis process using one or more solid oxide electrolysis cells and/or a low-temperature co-electrolysis process on an aqueous electrolyte, as was explained at the outset. It is also possible to use mixed forms of such electrolysis techniques within the scope of the present invention. In particular, the electrolysis process 10 may be carried out using one or more electrolysis cells, groups of electrolytic cells, and the like. A feed in the form of a material flow H supplied to the electrolysis process 10 is explained below. It comprises at least carbon dioxide, which is partially converted into carbon monoxide in the electrolysis process 10. In this way, using the electrolysis process 10, a raw gas A is obtained, having a composition that depends on the feeds supplied to the electrolysis process 10 and the electrolysis conditions.

The raw gas A contains hydrogen, carbon monoxide, and carbon dioxide. The carbon monoxide present in the raw gas A is one of the target products of the method 100. The carbon dioxide present in the raw gas A is the carbon dioxide that was supplied to the electrolysis process 10, but was not converted there. As already explained above, a corresponding raw gas A also contains fractions of hydrogen that should not be disregarded, since a formation of hydrogen in the electrolysis process 10 may not be completely avoided or is desired. As likewise explained above, in this embodiment, the present invention is aimed, in particular, at ensuring that such hydrogen does not pass into a carbon monoxide-rich gas product D of the method 100.

In the example shown, the raw gas A contains, for example, approximately 2.5% hydrogen, 34% carbon monoxide, and 63% carbon dioxide. In the example shown, it is formed, for example, in an amount of 478 standard cubic meters per hour and supplied completely to a membrane separation process 20. The raw gas A is present at a pressure of approximately 20 bar, for example. In the example shown, the electrolysis process 10 is carried out, for example, at a temperature of 30° C. The temperatures used in a corresponding LT electrolysis 10 are, for example, in a range of approximately 20 to 80° C. So as to achieve good electrolysis efficiency, it is necessary to use an excess of carbon dioxide in the electrolysis process 10. Complete conversion is therefore not possible, and non-converted carbon dioxide is found in the raw gas A.

In the membrane separation process 20, the raw gas A is processed to obtain a retentate mixture B that is enriched in carbon monoxide and depleted of carbon dioxide and hydrogen in comparison with the raw gas A, and a permeate mixture C that is depleted of carbon monoxide and enriched in carbon dioxide and hydrogen in comparison with the raw gas A. As mentioned, the use of the membrane separation process makes it possible to obtain a substantially hydrogen-free and carbon monoxide-rich product in a subsequent adsorption process, denoted here by 40. This will be explained below. While the removal of hydrogen essentially influences the purity of the carbon monoxide product D, the reduced carbon dioxide content in the retentate C leads to a marked reduction in the adsorber material, and thus to cost savings, since less carbon dioxide has to be adsorbed.

So as to set the temperature in the electrolysis process 10 and the membrane separation process 20, a heat exchange can be carried out upstream and/or downstream of the electrolysis process 10. A so-called feed-effluent heat exchanger can also be used, in which, for example, the material flow H to the electrolysis process 10 is heated, and the raw gas A is cooled for this purpose—for example, in a counter-flow. This is not illustrated in FIG. 1. A water separation process is also not illustrated, within the scope of which water vapor present in the raw gas A can be condensed out and, if necessary, fed back to the electrolysis process 10. After such a water separation process, renewed heating—typically by approximately 5 to 20° C.—can also be carried out upstream of the membrane separation process 20 so that the temperature level of the raw gas A is above the dew point.

So as to reduce possible oxygen fractions in the gas product D, a catalytic deoxo reactor can also be installed in the flow of the raw gas A so as to remove oxygen. By selecting suitable catalysts, hydrogen oxidizes to water starting at 70° C., for example, and carbon monoxide oxidizes to carbon dioxide starting at 150° C.

The retentate mixture B, which is formed as a retentate of the membrane separation process 20, contains, for example, approximately 0.2% hydrogen, 70% carbon monoxide, and 30% carbon dioxide in the example shown. In the example shown, it is formed, for example, in an amount of 202 standard cubic meters per hour. A membrane surface in the membrane separation process 20 is preferably designed in such a way that an accordingly low fraction of hydrogen is present in the retentate mixture B.

The permeate mixture C, which is formed as a permeate of the membrane separation process 20, is present, for example, at a pressure level of approximately 1.2 bar in the example shown. In the example shown, it is formed, for example, in an amount of 277 standard cubic meters per hour and has a hydrogen content of approximately 4%, a carbon monoxide content of approximately 7%, and a carbon dioxide content of approximately 88%.

In the example shown, a purge flow denoted by H₂ in the example shown, e.g., in an amount of approximately 20 standard cubic meters per hour, is separated from the permeate mixture C and is discharged from the method 100. In this way, an accumulation of hydrogen in a cycle formed in the method 100 by the recirculation of corresponding gas mixtures can be avoided. In other words, a portion of the hydrogen present in the permeate mixture C is discharged from the process here, wherein, by simply branching off and eliminating a portion of the permeate mixture C, the remaining components thereof are also removed in corresponding proportions. A portion of the permeate mixture C remaining after the separation is, as will also be explained below, fed back to the electrolysis process 10.

In the example shown, the retentate mixture B is subjected to the aforementioned pressure swing adsorption 40, by means of which a gas product D that is enriched in carbon monoxide and depleted of carbon dioxide in comparison with the retentate mixture B, and a residual mixture E that is depleted of carbon monoxide and enriched in carbon dioxide in comparison with the retentate mixture B, are formed.

The gas product D represents a typical product of the method 100, which, in the example shown, is formed, for example, in an amount of 100 standard cubic meters per hour, having a hydrogen content of approximately 0.3%, a carbon monoxide content of approximately 99.7%, and a carbon dioxide content of approximately 100 ppm. In the example shown, the residual mixture E is formed, for example, in an amount of 101 standard cubic meters per hour, having a hydrogen content of approximately 400 ppm, a carbon monoxide content of approximately 40%, and a carbon dioxide content of approximately 60%. The residual mixture E is also fed back to the electrolysis process 10 in the example shown.

In the example shown, a portion of the permeate mixture C remaining after the fraction denoted by H₂ has been branched off and the residual mixture E are combined before being fed back to the electrolysis process 10 to obtain a collection mixture forming a recirculation flow F, and are appropriately pressurized using a compressor 30. The extent of pressurization depends on the electrolysis conditions during the electrolysis process 10. As mentioned, a pressure of approximately 20 bar can be used during the electrolysis process 10, so that the mixture is pressurized to a corresponding pressure level. In the example shown, the collection mixture or the recirculation flow F is formed, for example, in an amount of approximately 358 standard cubic meters per hour, having a hydrogen content of approximately 3%, a carbon monoxide content of approximately 17%, and a carbon dioxide content of approximately 80%.

As an alternative to the illustration in this and the subsequent figures, the electrolysis process 10 can also be carried out at a pressure level lower than the inlet pressure of the membrane separation process 20. In this case, a corresponding raw gas compressor is used to compress the raw gas A. In such a case, it is possible to dispense with the compressor 30, and to supply the collection mixture or the recirculation flow F to the electrolysis process 10 at an appropriate lower pressure level. This variant is usually associated with higher compressor costs, since a larger gas flow has to be compressed.

Before being fed back to the electrolysis process 10, the collection mixture or the recirculation flow F is combined with a gaseous fresh feed G, which, in the example shown, is provided, for example, in an amount of 119 standard cubic meters per hour. The fresh feed G has a carbon dioxide content of approximately 99.9975%, for example. A material flow H, which is formed using the collection mixture F and the fresh feed G, is supplied to the electrolysis process 10. This results in an amount of approximately 477 standard cubic meters per hour for the material flow, having a hydrogen content of approximately 2%, a carbon monoxide content of approximately 13%, and a carbon dioxide content of approximately 85%. However, other fresh supplies G having typical purities can also be used. In particular, impurities of hydrogen, carbon monoxide, and water are typically not harmful in a feed of an LT electrolysis process, and can be tolerated. Other impurities such as saturated hydrocarbons, nitrogen, argon, and oxygen can also be tolerated in a feed within certain limits. In the case of HT electrolysis, water could be removed from the feed if the gas product to be produced is carbon monoxide.

FIG. 2 schematically illustrates a method according to another embodiment of the invention, which is denoted overall by 200.

The method 200 illustrated in FIG. 2 differs, in particular, from the method 100 illustrated in FIG. 1 in that a portion of the collection mixture, as illustrated here in the form of a material flow K, is fed back in the form of the recirculation flow F to the membrane separation process 20, and not to the electrolysis process 10. In other words, a first fraction of the collection mixture is combined with the raw gas A here and subjected to the membrane separation process 20, while a second fraction of the collection mixture is combined with a fresh feed G and fed back to the electrolysis process 10.

The fraction of carbon monoxide in the material flow H supplied to the electrolysis process 10 can be reduced by an appropriate partial recirculation. Depending on the particular design of the electrolysis process 10, such a reduction may be advantageous for the performance and/or the service life of the devices used herein. Since the membrane used in the membrane separation process 20 preferably selectively separates hydrogen and carbon dioxide from carbon monoxide, a partial recirculation has little influence on the downstream pressure swing adsorption process 40, provided that the membrane surface is adapted accordingly.

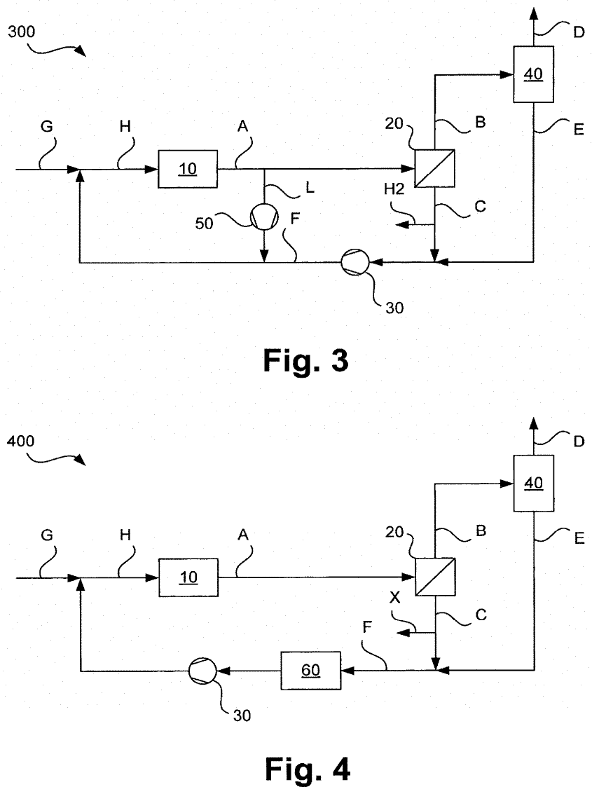

FIG. 3 schematically illustrates a method according to another embodiment of the invention, which is denoted overall by 300.

The method 300 illustrated in FIG. 3 differs, in particular, from the methods 100 and 200 explained above and illustrated in FIGS. 1 and 2 in that, here, a portion of the raw gas A, as illustrated in the form of a material flow L, is fed back to the electrolysis process 10 directly, i.e., bypassing the membrane separation process 20. A compressor 50 can be used for this purpose. In other words, a first fraction of the raw gas A is combined with the collection mixture or the recirculation flow F here and is fed back to the electrolysis process 10, and a second fraction of the raw gas A is subjected to the membrane separation process 20 to obtain the retentate mixture B and the permeate mixture C.

By means of appropriate partial direct recirculation to the electrolysis process, the carbon monoxide content in the electrolysis raw product, and thus the raw gas A, can be increased, in contrast to the method 200 illustrated in FIG. 2. This may have a positive effect on the overall separation sequence of the method 300. Since only the pressure loss of the electrolysis unit in which the electrolysis process 10 is carried out has to be overcome for appropriate recirculation, an inexpensive fan can be used as the compressor 50.

FIG. 4 schematically illustrates a method according to another embodiment of the invention, which is denoted overall by 400.

In contrast to the embodiments illustrated in the preceding figures, a hydrogen removal process 60 from the collection flow or recirculation flow F fed back to the electrolysis process 10 is carried out in the method 400 according to FIG. 4. As explained, in the process, partial or complete removal of hydrogen can take place. It is also possible to remove a portion of the carbon monoxide by oxidation to carbon dioxide. By setting the oxidation conditions (in particular, during the catalytic oxidation), first, hydrogen can be at least partially removed by oxidation to water, starting at approximately 70° C., and, at higher temperatures, starting at approximately 150° C., carbon monoxide can also be at least partially removed by oxidation to carbon dioxide. In particular, any remaining oxygen can also be removed using the second oxidation temperature. Thus, the content of carbon monoxide present in the recycle to the electrolysis process 10 can also be set and reduced, if this is advantageous for the life and operability of the electrolysis.

Such a procedure is, in particular, advantageous in cases in which a particularly pure carbon monoxide product in the form of the gas product D is desired, or a particularly high carbon efficiency of a corresponding process is to be achieved. In this way, an accumulation of hydrogen in the raw gas A can be further avoided. Such a selective removal of hydrogen can take place, for example, by catalytic oxidation, adding the oxygen by-product from the cathode side of the electrolysis process 10. During the catalytic oxidation, water is formed, which can be fed back to the electrolysis process 10 without any problem and can be separated downstream thereof. In addition to such catalytic removal, as an alternative, thermal removal by adding oxygen in a combustion chamber by partial oxidation is also possible. A corresponding thermal reaction can also take place in a gas turbine, for example, so as to achieve better energy efficiency of the method. In principle, the measures illustrated in FIGS. 2 and 3 for methods 200 and 300 can also be used in the method 400 illustrated in FIG. 4, or vice versa. In the method 400, inert components can be discharged in the form of a material flow X (purge). In all methods, as mentioned, the electrolysis process can also be carried out at a low pressure, and a raw gas compressor can also be used upstream of the membrane separation process, instead of the compressor 30.

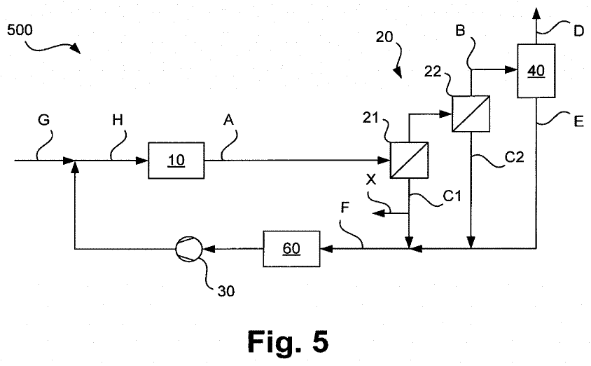

FIG. 5 schematically illustrates a method according to another embodiment of the invention, which is denoted overall by 500.

According to the method 500 illustrated in FIG. 5, it is provided that the membrane separation process 20 comprise at least two membrane separation steps 21, 22, wherein the permeate mixture C comprises permeate fractions C1, C2, each formed in the at least two membrane separation steps 21, 22. In this way, a separation action can be increased, wherein, so as to keep the number of required compressors small, a sequential arrangement, such as is shown in FIG. 5, is particularly advantageous. In principle, it is also possible to use the measures illustrated in FIGS. 2 and 3 for methods 200 and 300 in the method 500 illustrated in FIG. 5, or vice versa.

1. Method (100-500) for producing a gas product (D) containing at least carbon monoxide, in which method at least carbon dioxide is subjected to an electrolysis process (10) in order to obtain a raw gas (A) containing at least carbon monoxide and carbon dioxide, and the carbon dioxide contained in the raw gas (A) is partially or completely fed back to the electrolysis process (10), characterized in that the raw gas (A) is partially or completely subjected to a membrane separation process (20) to obtain a retentate mixture (B) and a permeate mixture (C), which is enriched in carbon dioxide in comparison with the raw gas (A), and that the retentate mixture (B) is partially or completely subjected to an adsorption process (40) to obtain the gas product (D), which is enriched in carbon monoxide and depleted of carbon dioxide in comparison with the retentate mixture (B), and a residual mixture (E), which is depleted of carbon monoxide and enriched in carbon dioxide in comparison with the retentate mixture (B).

2. Method according to claim 1, wherein the permeate mixture (C) and/or the residual mixture (E) are partially or completely fed back to the electrolysis process (10) in the form of one or more recirculation flows (F).

3. Method according to claim 2, wherein the electrolysis process (10) is carried out at a pressure level corresponding to a pressure level at which the raw gas (A) is supplied to the membrane separation process (20), the recirculation flow or flows (F) being compressed to the pressure level of the electrolysis process (10) using one or more compressors (30).

4. Method according to claim 2, wherein the electrolysis process (10) is carried out at a pressure level lower than a pressure level at which the raw gas (A) is supplied to the membrane separation process (20), the raw gas (A) being compressed to the pressure level of the membrane separation process (20) using one or more compressors.

5. Method (100-500) according to claim 2, wherein the raw gas (A) contains hydrogen, and the membrane separation process (20) is carried out in such a way that the retentate mixture (B) is depleted of hydrogen in comparison with the raw gas (A), and the permeate mixture (C) is enriched in hydrogen in comparison with the raw gas (A).

6. Method (100-500) according to claim 5, wherein at least a portion of the hydrogen present in the permeate mixture (C) from the method (100) is discharged.

7. Method (400-500) according to claim 5, wherein at least a portion of the recirculation flow (F) is subjected to a hydrogen removal process (60)—in particular, in the form of catalytic and/or non-catalytic oxidation—and what remains after the hydrogen removal process (60) is partially or completely fed back to the electrolysis process (10).

8. Method (200) according to claim 1, wherein a first fraction of the permeate mixture (C) and/or of the residual mixture (E) is combined with the raw gas (A) in the form of the recirculation flow or flows (F) and subjected to the membrane separation process (20), and a second fraction of the permeate mixture (C) and/or of the residual mixture (E) is combined with a fresh feed (G) and fed back to the electrolysis process (10).

9. Method (300) according to claim 1, wherein a first fraction of the raw gas (A) is combined with the recirculation flow or flows (F) and fed back to the electrolysis process (10), and a second fraction of the raw gas (A) is subjected to the membrane separation process (20) to obtain the retentate mixture (B) and the permeate mixture (C).

10. Method (500) according to claim 1, wherein the membrane separation process (20) comprises at least two membrane separation steps (21, 22), the permeate mixture (C) comprising permeate fractions (C1, C2), each formed in the at least two membrane separation steps (21, 22).

11. Method (100-500) according to claim 1, wherein the permeate mixture (C) and the residual mixture (E) are each formed at a pressure level of 1 to 10 bar.

12. Method (100-500) according to claim 1, wherein the gas product (D) formed is carbon monoxide or a carbon monoxide-rich gas mixture, the gas product (D) containing 90 to 100% carbon monoxide.

13. Method (100-500) according to claim 1, in which the gas product (D) formed is synthesis gas, wherein the gas product (D) contains in total 90 to 100% carbon monoxide and hydrogen, and wherein a ratio of hydrogen to carbon monoxide in the gas product is 1 to 4 and/or the gas product has a stoichiometric number of 0.8 to 2.1.

14. Method (100-500) according to claim 1, wherein the electrolysis process (10) in the form of a high-temperature electrolysis process using one or more solid oxide electrolysis cells and/or a low-temperature co-electrolysis process is carried out on a liquid electrolyte.

15. System for producing a gas product (D) containing at least carbon monoxide, comprising an electrolysis unit configured to subject at least one carbon dioxide to an electrolysis process (10) to obtain a raw gas (A) containing at least carbon monoxide and carbon dioxide, and comprising means configured to partially or completely feed back the carbon dioxide contained in the raw gas (A) to the electrolysis process (10), characterized by means configured to partially or completely subject the raw gas (A) to a membrane separation process (20) to obtain a retentate mixture (B) and a permeate mixture (D), which is enriched in carbon dioxide in comparison with the raw gas (A), and means configured to partially or completely subject the retentate mixture (B) to a pressure swing adsorption process (40) to obtain the gas product (D), which is enriched in carbon monoxide and depleted of carbon dioxide in comparison with the retentate mixture (B), and a residual mixture (E), which is depleted of carbon monoxide and enriched in carbon dioxide in comparison with the retentate mixture (B).
